(19) United States
(12) Patent Application Publication
(10) Pub. No.: US 2005/0220021 A1
(43) Pub. Date: Oct. 6, 2005

(54) Methods and arrangement for power transmission over telephone lines

(76) Inventors: John David Sosnowski, Wharton, NJ (US); Tom Peter Sterk, Randolph, NJ (US)

Correspondence Address: HARNESS, DICKY & PIERCE, P.L.C., P.O. Box 8910, Reston, VA, 20195, US

(21) Appl. No.: 10/815,812

(22) Filed: Apr. 2, 2004

(51) Int. Cl. H04L 12/26

(52) U.S. Cl. 370/235; 370/395.21

(57) ABSTRACT

Methods and an arrangement for transmitting electrical power from a power source to a remote load over a telephone twisted pair are provided so as to power the load. The power source may transmit a plurality of electrical power feeds over a plurality of twisted pairs, each power feed limited to no more than 100 watts in a given twisted pair. One or more (or all) of a plurality of independent, power converters at the remote load may generate a voltage output based on receipt of a given power feed from a corresponding twisted pair.

### BACKGROUND OF THE INVENTION

1. Field of the Invention

The present invention relates generally to transmitting power over telephone lines.

2. Description of Related Art

Remote power feeding at 50 vdc to 60 vdc is well known in an analog telephone system such as a Plain Old Telephone System (POTS). Remote power feeding has also been used at higher voltages for users of long distance lines in many countries. Higher voltages are also planned to be expanded to subscriber lines, such as the family of digital subscriber lines (xDSL).

A typical POTS may include a central office (CO) connected to a remote load via a pair of copper lines, known as a twisted pair. The early phone network consisted of a pure analog system that connected telephone users directly by a mechanical interconnection of copper wires. This system was inefficient and prone to breakdown and noise, and did not lend itself easily to long-distance connections.

Beginning in the 1960s, the telephone system gradually began converting its internal connections to a packet-based, digital switching system, known as a Public Switched Telephone Network (PSTN). Today, nearly all voice switching in the United States is digital within the PSTN. The signal coming out of the phone set is analog. It is usually transmitted over a twisted pair cable still as an analog signal. At the CO, this analog signal is usually digitized, using 8000 samples per second and 8 bits per sample, yielding a 64 kb/s data stream (DSO). Several such data streams are usually combined into a fatter stream: in the United States, 24 channels are combined into a T1; in Europe, 31 DSO channels are combined into an E1 line. This can later be further combined into larger chunks for transmission over high-bandwidth core trunks. At the receiving end the channels are separated, the digital signals are converted back to analog and delivered to the receiving telephone.

A CO may have one or more CO power nodes for generating high voltage over the twisted pair. The power supply for generating high voltage power at the CO power node may be an AC mains supply, which is an external AC power distribution system supplying power to the power node equipment. Such power sources include public or private utilities and equivalent sources such as motor driven generators and uninterruptible power supplies. The CO power node may include an AC/DC power converter to convert the AC voltage to a DC voltage for transmission over the twisted pair. Alternatively, if the power source is a DC voltage supply, a step down DC/DC power converter may be provided at the CO power node.

The high DC voltage transmitted over the twisted pair is received by load equipment. The load equipment typically includes a voltage converter such as a DC/DC converter to convert the voltage to a lower voltage used to power downstream loads, such as circuitry and electronics.

Telecommunications equipment such as the above, by nature of its application in a given telecommunications network, may be exposed to one or more sources of electromagnetic energy. Accordingly, several standardizing bodies and other regulatory agencies such as Underwriters Laboratory (UL), and the National Electrical Code (NEC) has specified certain voltage, current and power limits for the power that may be transmitted over twisted pair telephone wires.

For example, the International Electrotechnical Commission (IEC), in collaboration with UL and standard organizations such as the International Organization for Standardization (ISO), has developed safety standards for telecommunications equipment. One such developing standard is the IEC 60950 standard, Part 21, Remote Power Feeding. Part 21 of IEC 60950 applies to information technology equipment intended to supply and receive operating power via a telecommunications network, where the voltage exceeds the limits for telecommunication network voltage circuits (TNV). A TNV circuit is a circuit which is in the equipment and to which the accessible area of contact is limited and that is so designed and protected that, under normal operating conditions and single fault conditions, the voltages do not exceed certain limits, as specified in the standards.

Telcordia Technologies has also published electromagnetic compatibility and electrical safety guidelines followed by much of the telecommunications industry, including generic criteria for network telecommunications equipment in the document GR-1089-CORE, issued October 2002. Section 7 of this document specifies electrical safety guidelines intended to protect persons from harm by limiting the voltages and currents that are intentionally applied to communications circuits and to energize parts of network equipment such as a twisted pair. In addition to voltage and current limits, Section 7 describes an overall power limitation imposed on power sources that applies to communication wiring such as a twisted pair.

For example, subsection 7.6 of GR-1089 specifies a power limitation requirement in that “sources that may be applied to communication wiring shall be limited to a rating not exceeding 100 volt-amperes. Paralleling of power sources over multiple communication wires for the purpose of delivering in excess of 100 va shall not be permitted. This power limitation is not intended to apply to the central office power and battery plant”. However, the power limitation requirement in subsection 7.6 does not preclude the use of several individual 100 volt-ampere (watt) power sources, each of which needs a separate set of communication lines to a separate remote load.

Conventional efforts to meet the power limitation described in GR-1089 have been limited to the use of diode “ORing” of the power sources at a receiving end such as at the load equipment, and then feeding the resulting high voltage bus at the load equipment to a single converter. However, the conventional solution does not provide separate remote loads as described by GR-1089. Further, the conventional approach prevents implementing ground fault interruption (GFI) by conventional methods. The intent of a GFI is to interrupt the power if an unintentional ground current is present. The purpose of this interruption is to limit the likelihood of electric shock to personnel. The rationale behind this is that an electric shock would most likely be caused by a person contacting one conductor and simultaneously being in electrical contact with (earth) ground. The current would flow from the conductor through the person to ground. If the current to ground can be interrupted, the person would not be shocked.

FIGS. 1A and 1B illustrate prior art ground fault interruption configurations between a power source and a load. Referring to FIG. 1A, there is shown a twisted pair 130 of telephone wires connecting a power source 110 to a load 120. In practice, the current to ground cannot be conveniently detected. Rather, a GFI device 140 measures the imbalance between the currents (current path shown by arrows) in the two power conductors (here, the two wires of the twisted pair 130). If the two conductors have different currents, the imbalance must be a result of an unintentional path to ground. In FIG. 1A, the GFI device 140 thus measures an imbalance in current between the wires of the twisted pair 130, and any non-zero difference causes power source 110 to be disabled.

Detecting the current imbalance is not suitable if there are more than two power conductors. For example, as shown in FIG. 1B, there are two power sources 110a and 110b powering a single load 120 via two sets of power conductors (twisted line pairs 130a and 130b). In this example, detecting current imbalance is not possible since any two conductors could have a current imbalance if the remaining conductors share the same load 120. In other words, a non-zero difference in current in twisted pair 130a could be caused by interaction with power source 110b, which would not be a valid criteria for disabling power source 110a. FIG. 1B also illustrates the conventional use of diode “ORing” of the power sources 110a and 110b, in which diode pairs 155a and 155b are provided at a receiving end such as at the load equipment 120. The resulting high voltage bus (here ±190 vdc) may be fed at the load equipment 120 to a single converter (not shown).

FIG. 2 illustrates a prior art load sharing arrangement. FIG. 2 illustrates a receiving end 250 of a prior art telecommunications arrangement such as a POTS. Receiving end 250 may include a remote power source 260 interconnected to downstream electronics 270 via a pair of bus wires 267. FIG. 2 also illustrates the conventional use of diode “ORing”, in which diode pairs 255a-c are provided at the compact remote power source 260 of the receiving end 250.

Remote power source 260 may include a plurality of power converters 265a-c receiving electrical power from a source (such as a CO power node) via sets of twisted pairs and converting the received voltage to a lower voltage output to pair load via corresponding bus lines 230a-c which may be combined on bus lines 267 to power downstream electronics 270. In order to implement load current sharing between a CO (not shown) and the receiving end 250, additional circuitry must be added in the prior art arrangement so that all the power converters 265a-c at the receiving end 250 (typically −48 V_{DC} voltage converters) interact in such a manner so as to affect sharing of the total load. For example, a central controller 245 of the remote power source 260 may receive current inputs from current sensors 240a-c to control outputs (via control circuits 275a-c ) of power converters 265a-c. The central controller 245 thus affects all three converters 265a-c in the conventional load sharing arrangement. Accordingly, the prior art approach requires that each power converter 265a-c be inter-dependent on all the other power converters 265a-c, which does not provide separate remote loads as prescribed by GR-1089.

Further, UL has set transient tests to be performed to ensure that converters such as power converters 265a-c at the receiving end 250 are not damaged due to severe transient conditions. In order for telecom equipment to satisfy the UL transient requirements, a combination of a Sidactor and a fuse is typically used. The Sidactor is a voltage controlled semiconductor switch that shorts the transient to ground. A series fuse is used to protect the Sidactor during severe transients.

In an arrangement such as shown in FIG. 1A, where the power supply is a DC voltage, use of a Sidactor and fuse for transient protection may be unacceptable because the DC power on the twisted pair 130 may prevent the Sidactor from resetting after a transient has tripped the Sidactor A Sidactor is a clamping device. If the voltage across the Sidactor is less than its threshold, the Sidactor acts as a high impedance device and does not conduct current. When a large voltage transient exceeds the Sidactor's threshold, the Sidactor provides protection by presenting a very low impedance, effectively shorting the transient. The Sidactor will continue to clamp until the current through the Sidactor falls below a prescribed current level. If dc power is present on the Sidactor from the power source, the Sidactor current may not drop low enough for the Sidactor to reset, since the current across the Sidactor may exceed the reset threshold for the Sidactor. For safe operation, the Sidactor must thus be used in conjunction with a series fuse. Operation of the Sidactor may result, in certain instances, in opening or blowing of the associated fuse. A blown fuse may take many users out of service, potentially requiring necessary repairs to the underlying circuitry.

### SUMMARY OF THE INVENTION

Exemplary embodiments of the present invention are directed to methods and an arrangement for transmitting electrical power from a power source to a remote load over a telephone twisted pair so as to power the load. The power source may transmit a plurality of electrical power feeds over a plurality of twisted pairs, each power feed limited to no more than 100 watts in a given twisted pair. Each of a plurality of independent, remote power converters at the remote load may generate a voltage output based on receipt of a given power feed from a corresponding twisted pair.

### BRIEF DESCRIPTION OF THE DRAWINGS

Exemplary embodiments of the present invention will become more fully understood from the detailed description given herein below and the accompanying drawings, wherein like elements are represented by like reference numerals, which are given by way of illustration only and thus are not limitative of the exemplary embodiments of the present invention and wherein:

FIGS. 1A and 1B illustrate prior art ground fault interruption configurations between a power source and a load.

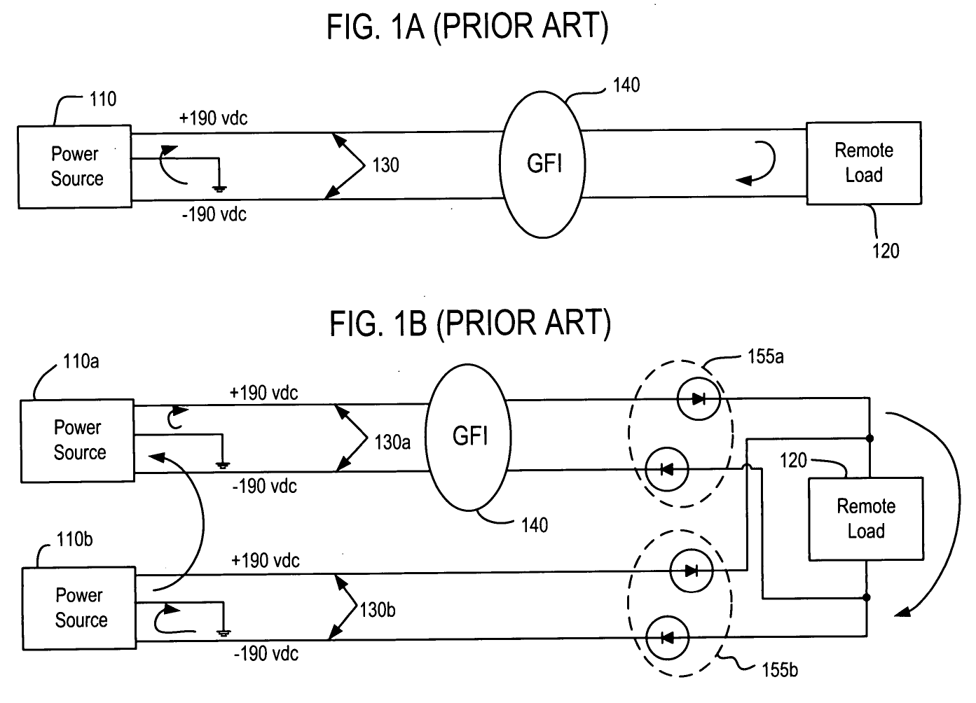

FIG. 2 illustrates a prior art load sharing arrangement.

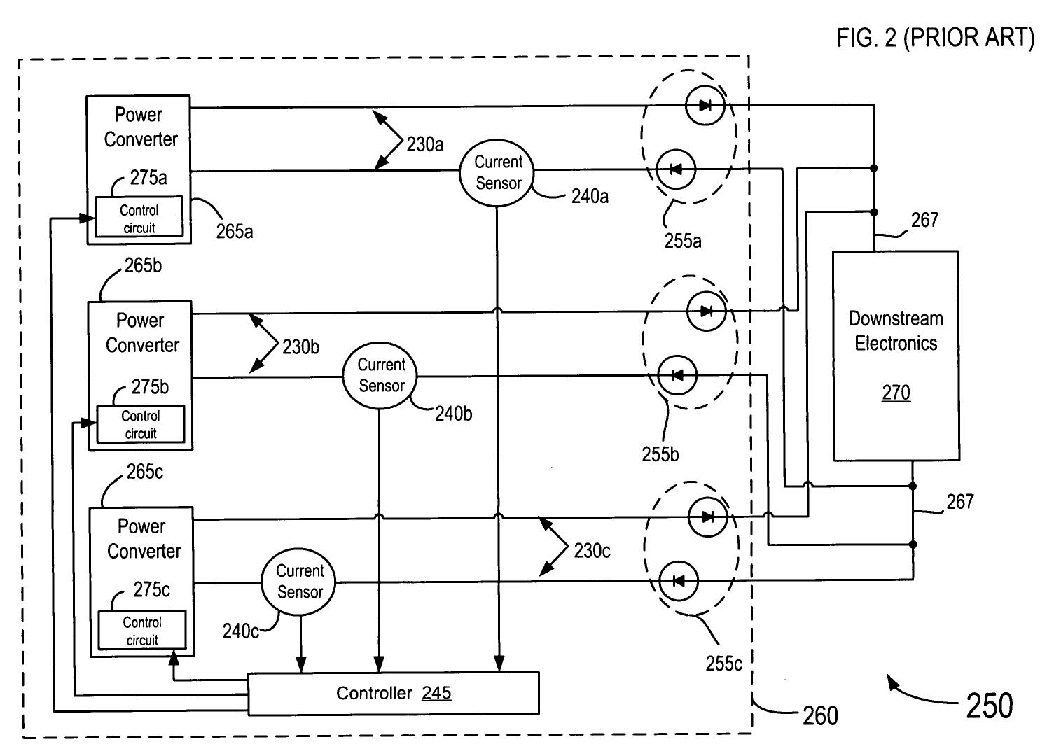

FIG. 3 is a block diagram illustrating a method of transmitting electric power over telephone wires in accordance with an exemplary embodiment of the present invention.

FIG. 4 is a graph of voltage versus current to illustrate the characteristics of the 100 VA power limiter shown in FIG. 3.

FIG. 5 is a partial circuit diagram illustrating an input to a given power converter of a remote load power supply in accordance with an exemplary embodiment of the present invention.

### DETAILED DESCRIPTION OF THE EXEMPLARY EMBODIMENTS

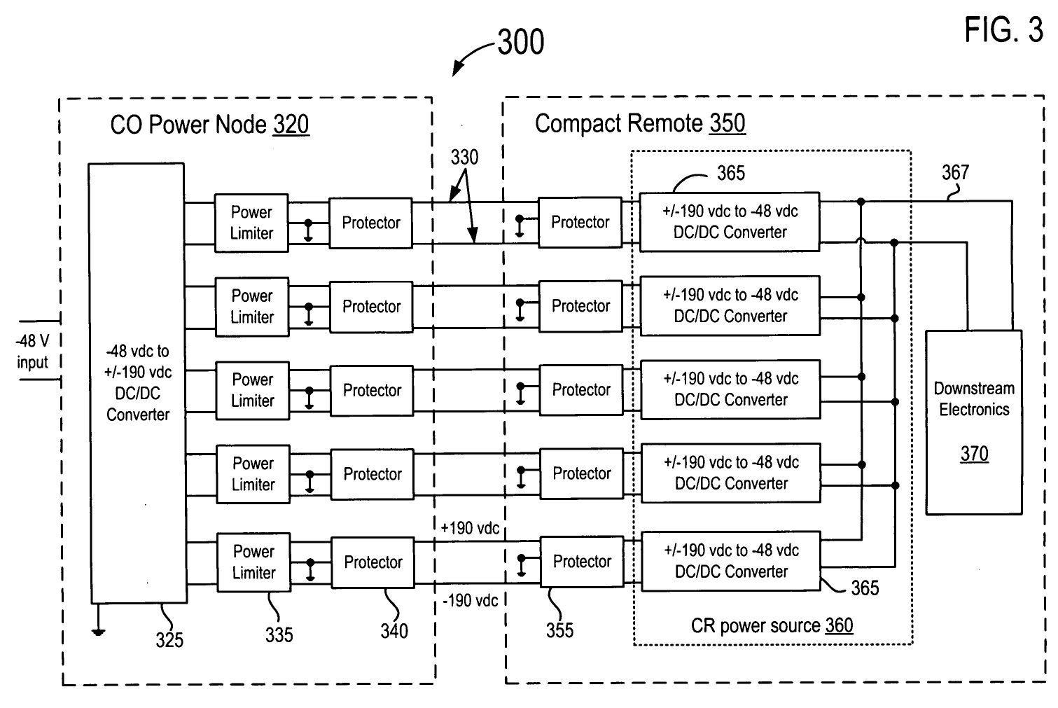

FIG. 3 is a block diagram illustrating a method of transmitting electric power over telephone wires in accordance with an exemplary embodiment of the present invention. There is shown an exemplary arrangement 300 for transmitting power over telephone wire pairs so as to satisfy the Telcordia GR-1089 power limitation requirement. In FIG. 3, a power supply voltage −48 vdc may be received at a CO power node 320. The CO power node 320 may include one or more DC/DC converters 325, here shown as single 48 vdc to ±190 vdc DC/DC bulk power converter. Connected to the output of the bulk power converter 325 may be a plurality of telephone wire twisted pairs 330.

Within CO power node 320, each twisted pair 330 includes a power limiter 335. Power limiter 335 serves to limit power across a given twisted pair 330, and thus may be occasionally referred to hereafter as a ‘power source 335’. Power limiter 335 may also implement a GFI function, although a GFI function may alternatively be provided by a separate device in each twisted pair 330 (not shown). Each twisted pair 330 may also include a transient protector 340 connected between the wires of the twisted pair 330, as shown in FIG. 3, for example.

At the receiving end, there is shown load equipment, in the exemplary embodiment referred to as a compact remote 350. The compact remote 350 may include corresponding transient protectors 355 between the wires of the twisted pairs 330 and may include a remote power supply 360 powering downstream electronics 370, such as compact remote telecom electronics, for example.

Remote power supply 360 may include one or more power converters 365. Occasionally hereafter power converters 365 may be referred to as ‘separate remote loads 365’ of the compact remote 350. Accordingly, at the receiving end for each twisted pair 330, there may be provided a separate transient protector 355 and a corresponding independent, isolated, power converter 365. Each power converter 365 may be a DC/DC converter with isolation (i.e., transformer) and with an input of ±190 vdc and an output of −48 vdc. The outputs of each of the power converters 365 may be combined as a single output from the compact remote power supply 360, via bus lines 367 to power downstream electronics 370.

The arrangement 300 may enable a method for delivering greater than the 100 volt-amperes (watts) of power specified by GR-1089 by combining multiple power sources at the load equipment (compact remote 350). Additionally, at the source end (CO power node 320), a single isolated high voltage power source such as converter 325, or multiple individual, isolated high voltage power sources may provide outputs that are each limited to 100 watts. This power limiting effect may be provided by independent power limiters 335 provided at the source end (i.e., at CO power node 320), for example.

As discussed above, at the receiving end (compact remote 350) there may be provided multiple, independent, isolated loads (i.e., separate remote loads 365) each accepting a single 100 watt limited power feed, and producing a single low voltage output (−48 vdc, for example) via bus lines 367 to power downstream electronics 370. As shown in FIG. 3, the outputs of the isolated, independent remote power converters 365 may be combined to produce a single output that is greater than 100 watts to power downstream electronics 370, thereby complying with the GR-1089 power limitation, that the use of several individual 100 volt-ampere (watt) power sources is permitted so long as each of has a separate set of communication lines to a separate remote load 365.

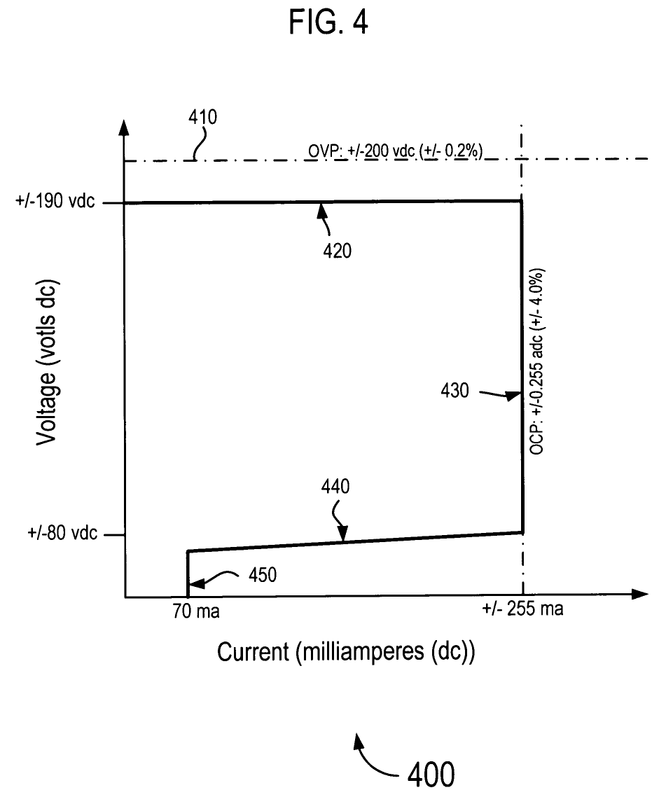

FIG. 4 is a graph of voltage versus current to illustrate the characteristics of an exemplary power limiter 335 as shown in FIG. 3. Referring to FIG. 4, graph 400 illustrates the voltage-current (VI) characteristics of the 100 VA power limiter 335. In FIG. 4, line 410 shows over-voltage protection set in the power limiter 335 at a given threshold of 200 vdc, ±0.2%, and a current limit threshold of 0.255 amperes (adc)±4.0% Limiter 335 may be designed to source ±190 vdc at up to 0.255 amperes, hence its reference as a power source. This may be shown by the horizontal line segment 420, which may be referred to as a ‘nominal’ line or as representing a nominal region. If the power source 335 is loaded beyond 0.255 amperes, the voltage will decrease, maintaining a constant 0.255 amperes. This vertical line segment 430 may be referred to as a ‘current limiting line’ or current limiting region, for example in FIG. 4.

If the output voltage is reduced to ±80 vdc as a result of the current limiting action, the voltage will ‘foldback’, thus reducing the current. In FIG. 4, this may be shown as foldback line segment 440 or foldback region. Once the current falls below 70 mA, the output of the power source 335 will be disabled. This may be shown as a ‘restart’ line segment 450 or restart region in FIG. 4.

Normally, the power limiter 335 will be operating in the nominal region or the current limiting region of the graph 400. As the loading of the source (power limiter 335) varies, the source will provide ±190 volts up to the 100 VA limit. If the limit is reached, the source will continue to provide power, but will reduce its output voltage as the load is increased. This may have the effect of essentially forcing the sharing of the load among multiple power limiters 335.

The foldback and restart regions may be provided to allow for the resetting of protective devices such as protectors 340 and 355 in arrangement 300. Protective devices 340 and 355 may exhibit a voltage clamping nature, and the source 335 should foldback and reset to ensure that the protective devices 340 and 355 revert to a non-conductive state.

In another exemplary embodiment, the arrangement 300 of FIG. 3 may provide a method of apportioning a load between the receiving converters 365 in the compact remote 350. Separate receiving converter outputs, in general, cannot be combined without ensuring that their outputs share the load. Accordingly, the power limitation of the power source 335 (here shown as ±190 volts DC) may be utilized to provide a sharing between multiple feeds over twisted pairs 330 to the compact remote 350.

For example, the separate receiving converters 365 may each be allowed to source as much power as is required. If any one given converter 365 attempts to source power in excess of the power limitation of 100 VA, the input to that converter 365 (e.g., power limiter 335) should also provide more power. Since the power source (power limiter) 335 is limited to 100 watts per each output, each power limiter 335 may enforce a limitation on the amount of power that its corresponding receiving converter 365 may provide. As each receiving converter 365 approaches the 100 watt limitation, the next receiving converter 365 may be forced to provide more power, resulting in a cascaded-type of sharing of the load 370 at the compact remote power source 360. The converters 365 are independent of each other, but the combined output at twisted pair 367 is a result of apportioning the total load to power downstream electronics 370 among all the converters 365.

Such an approach may be useful in that it is not necessary to know how many independent remote loads (i.e., how many power converters 365) will be combined at the compact remote 350. Such an approach may provide a more efficient power sharing between an arbitrary number of separate remote power converters 365.

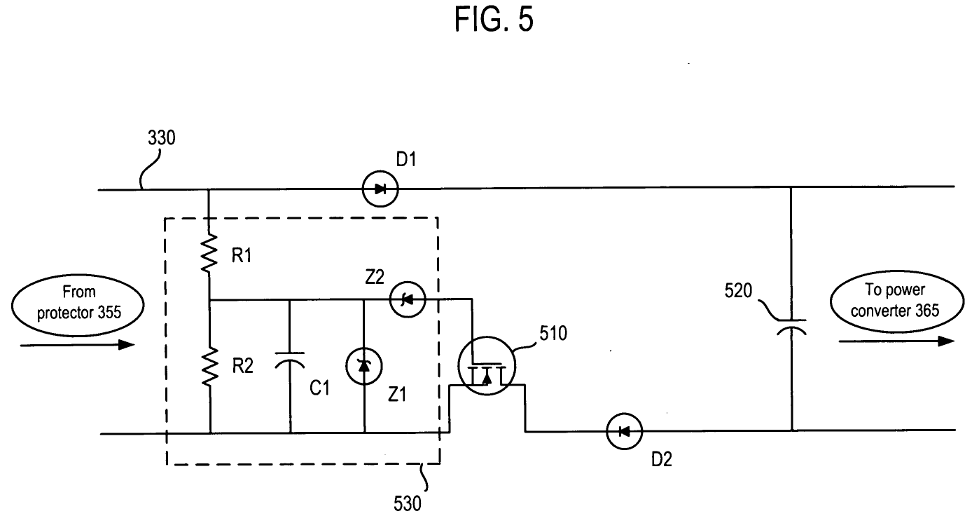

FIG. 5 illustrates the input to a given power converter 365 in the compact remote power supply 360. Another exemplary embodiment may be directed to a method of ensuring that the multiple receiving converters 365 share the load during an initial power-up of the arrangement 300.

Referring to FIG. 5, as the input to a given power converter 365 via a given twisted pair 330 between a transient protector 355 and the converter 365, there may be provided a switch 510 that provides for a controlled startup. Switch 510 may be embodied as a 1 kv metal oxide semiconductor field effect transistor (MOSFET), for example. Additionally, an energy storage capacitor 520 may be provided between the wires of the twisted pair 330 in the input to converter 365, and a set of power diodes D1 and D2 (ORing diodes) provided in each wire of the twisted pair 330. Energy storage input capacitor 520 may be a 150 μF capacitor for example, and ORing diodes D1 and D2 may be embodied as 500 volt diodes, although capacitor 520 and diodes D1 and D2 are not limited to these exemplary values.

Further, a delay and protection circuit 530 may be included and operatively connected to the gate of MOSFET switch 510, as shown in FIG. 5. For example, delay and protection circuit 530 may include resistors R1 and R2, capacitor C1, and zener diodes Z1 and Z2. Exemplary values for these components may include, but are not limited to: R1=400 kΩ, R2=38 kΩ, C1=3.3 μF, Z1 may be a 30 volt zener diode and Z2 may be a 5.1 volt zener diode. The delay and protection circuit 530 may provide a fixed turn-on delay to ensure proper startup of multiple converters 365. When voltage is initially applied to the left side of FIG. 5, the MOSFET 510 is off. After the delay set by delay and protection circuit 530 elapses, the MOSFET 510 will switch on, allowing capacitor C2 520 to charge.

The delay and protection circuit 530 may also provide detection of overvoltage conditions that can result from an accidental connection of an ac mains to the input of a given converter 365. The delay and protection circuit 530 detects the ac voltage and turns MOSFET 510 off, preventing the ac mains voltage from damaging the converter 365 or connected downstream electronics 370.

As discussed above, the receiving remote power supply 360 may include a plurality of independent power converters 365 that take incoming power feeds from corresponding multiple independent power sources (power limiters 335 of CO power node 320, via power converter 325) and provide a single output via twisted pair 367 to power remote load 370. During startup, if less than a minimum given number of converters 365 are active, there may be insufficient power for the load. Since the converters 365 are independent, it may thus be desirable to coordinate the startup of the converters 365.

Referring again to FIG. 5, and as discussed above, the input to each receiving converter 365 may include an energy storage input capacitor 520. Once the capacitor voltage of energy storage input capacitor 520 exceeds a given upper threshold, a timing circuit (not shown, but part of converter 365) is started. When a timer in the timing circuit times out, the power converter 365 may be automatically enabled. This is contrary to a conventional power converter, because in the conventional power converter, there is no intentional delay before the output is enabled. The purpose of this delay provided by a delay circuit part of power converter 365 (not shown) is to ensure that the energy storage capacitor 520 charges up to the full available voltage level delivered by the power source (power limiter) 335 to its corresponding power converter 365 at the remote power source 360.

When the timer times out and the converter 365 is enabled, power may be delivered to the downstream electronics 370. This causes the voltage on the energy storage capacitor 520 to drop. The rate of drop may be determined by one or more of the amount of power delivered to the load 370 and the voltage drop on the wiring (twisted pair 330) between the power limiter 335 at the CO power node 320 and the receiving converter 365. Once the voltage on the energy storing capacitor 520 drops below a lower given threshold, power out of the converter 365 be terminated. This will re-start the cycle, i.e. energy storage input capacitor 520 will begin to charge until it is fully charged.

Accordingly, each converter 365 may independently cycle on and off due to the MOSFET 510 as described above. Each of the independent converters 365 will remain on only if all the converters 365 are on at the same time, resulting in stable power operation of the load 370. Since the converters 365 are independent, the cycling should be synchronized to ensure that the load 370 will turn on. In other words, all converters 365 should be on simultaneously so that the compact downstream electronics 370 can be supported. If an insufficient number of converters 365 are on, the load 370 will exceed the combined capacity of the converters 365 and the converters 365 will cycle off.

Synchronization may be achieved by selecting an upper and a lower voltage threshold for energy storage input capacitor 520 in order to turn on the delay, and also by selecting the desired size of the energy storage capacitor 520 such that a probability that all the converters 365 are simultaneously being enabled is substantially high. Synchronization may be affected by one or more of the voltage thresholds set for capacitor 520, the value selected for capacitor 520, the loading presented at downstream electronics 370, resistive or impedance losses in the wires of the twisted pair 330, the voltage and current limits of the power limiter 335, the number of converters 365 that are simultaneously active, the degree of simultaneity of operation of the converters 365, etc

In accordance with another exemplary embodiment, the receiving power converters 365 at the compact remote 350 (or power converter 325 at the CO power node 320) may be designed to withstand severe transients, and to satisfy UL transient requirements, without using a fuse or a shorting device such as a Sidactor voltage controlled semiconductor switch. This may be accomplished by inserting a series switch (MOSFET 510 in FIG. 5) in the input to each converter 365. The series switch 510 may temporarily disconnect the twisted pair 330 providing power to the converter 365 during the transient and automatically reconnects the twisted pair 330 when the transient has passed. Alternatively, series switch 510 may be configured to block a substantial portion of a severe transient while allowing a smaller, non-damaging portion of the transient to pass through converters 365, for example. For typical transients, the energy storage capacitors 520 on the input of the power converters 365 should have a sufficient capacity, so as to allow for substantially uninterrupted operation both before and after the transient.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

1. A method of transmitting electrical power from a power source to a remote load over a telephone twisted pair, comprising:
transmitting, from the power source, a plurality of electrical power feeds over a plurality of twisted pairs, each power feed limited to no more than 100 watts in a given twisted pair,
generating, at each of a plurality of remote, independent power converters, a voltage output based on receipt of a given power feed from a corresponding twisted pair; and
combining the voltage outputs of each of the power converters to power a downstream remote load.

2. The method of claim 1, further comprising:
limiting current over the twisted pair between of the power source and a given remote power converter so that feed power over a corresponding given twisted pair between the power source and given remote power converter does not exceed 100 watts.

3. The method of claim 1, wherein each remote power converter receives a feed of electrical power from the source over a single twisted pair.

4. The method of claim 1, further comprising:
protecting against transient-induced damage at the power source or at a given remote power converter without employing a fuse or a voltage controlled shorting switch.

5. The method of claim 4, wherein the protecting step includes momentarily interrupting power on a given twisted pair during the transient and re-connecting pair to the twisted pair after the transient has passed.

6. The method of claim 5, wherein effects of the transient do not reflect in an interruption of power to the load.

7. The method of claim 1, further comprising:
delaying, during a start-up operation, enabling of a low voltage to be output from at least one of the plurality of the remote power converters so as to synchronize the plurality of independent remote power converters at the load.

8. The method of claim 7, wherein said step of delaying is a function of at least one a size of an energy storage capacitor provided in an input path to a given remote power converter, voltage thresholds set for the energy storage capacitor, loading presented by the load, resistive or impedance losses in a given twisted pair, voltage and current limits of a power limiter provided at the source to limit power to 100 VA, the number of remote power converters that are simultaneously active, and a degree of simultaneity of operation of the remote power converters.

9. The method of claim 1, wherein the plurality of output voltages are combined so as to power a downstream remote load in excess of 100 watts.

10. An arrangement for transmitting electrical power from a central office to a compact remote over a telephone twisted pair, comprising:
at least one isolated power converter at the source for transmitting electrical power feeds over a corresponding twisted pair, each power feed limited to no more than 100 watts in a given twisted pair, and
a plurality of separate remote loads at the compact remote for producing a voltage output based on receipt of a given power feed from a corresponding twisted pair, the compact remote combining the voltage outputs of each of the remote power converters to power downstream electronics.

11. The arrangement of claim 10, further comprising:
at least one power limiter provided in each twisted pair between the at least one source power converter and a given remote power converter at the compact remote so that feed power over the twisted pair does not exceed 100 watts.

12. The arrangement claim 10, further comprising:
a transient protection device provided in each twisted pair for protecting against transient-induced damage to power converters at the central office or at the compact remote.

13. The arrangement claim 12, wherein the transient protection device does not include a fuse or a voltage controlled switch.

14. The arrangement claim 12, wherein the transient protection device is a series switch that disconnects a given power converter from a given twisted pair to momentarily interrupt power on the given twisted pair during the transient and re-connects the given power converter to the given twisted pair after the transient has subsided.

15. The arrangement claim 12, wherein the downstream electronics represents a load requiring in excess of 100 watts.

16. A method of apportioning electrical power received over a plurality of telephone twisted pairs at a plurality of independent remote power converters of a remote power source so not to exceed 100 watts of power on a given twisted pair, comprising:
controlling, from at least one power source, electrical power over each twisted pair so that electrical power on a given twisted pair does not exceed 100 watts, the at least one power source enforcing a power limitation on how much a given remote power converter can provide to power downstream electronics so as to provide cascaded sharing of power at the remote power source.

17. In load equipment adapted for receiving high-voltage electrical power from a central office source via at least one telephone wire twisted pair and converting the high voltage power to a low-voltage output for powering a load, the load equipment including a plurality of independent, isolated power converters, a method of synchronizing the power converters during start-up for sharing the load, comprising:
delaying, during the start-up operation, enabling of a low voltage to be output from at least one of the plurality of isolated power converters so as to synchronize the plurality of isolated power converters.

18. The method of claim 17, wherein said step of delaying is a function of at least one threshold for initiating a delay.

19. The method of claim 17, wherein said step of delaying is a function of a size of an energy storage capacitor in an input path to a given load power source.

20. In load equipment adapted for receiving high-voltage electrical power from a central office source via at least one telephone wire twisted pair and converting the high voltage power to a low-voltage output for powering a load, the load equipment including a plurality of independent, isolated remote power converters, each remote power converter including a capacitor on an input thereto that is tied to a timer of the remote power converter for delaying, during a start-up operation, enabling of a voltage to be output from the corresponding remote power converter until the capacitor has fully charged, so as to synchronize the plurality of remote power converters during start-up.

21. In an arrangement for transmitting electrical power over a telephone twisted pair between a central office power source and a compact remote power source for powering remote electronics downstream from the compact remote power source, a device for protecting against transient damage, comprising:
a series switch that disconnects power from the twisted pair to momentarily interrupt power on the given twisted pair during the transient and re-connects power to the given twisted pair after the transient has subsided.

22. The arrangement of claim 21, wherein
the central office power source includes at least one isolated source power converter for transmitting electrical power feeds over at least one twisted pair, and
the series switch is arranged between the two wires of the twisted pair at the at least one source power converter.

23. The arrangement of claim 21, wherein
the compact remote power source includes at least one isolated power converter for producing a voltage output based on receipt of a given power feed from a corresponding twisted pair, and
the series switch is arranged between the two wires of the twisted pair at the at least one remote power converter.

24. A central office power node for delivering electric power over a telephone twisted pair to a compact remote for powering remote downstream electronics, comprising:
at least one isolated source power converter for converting electrical power a source voltage to be transmitted over at least one twisted pair, and
at least one power limiter provided in the at least one twisted pair for limiting electric power over the twisted pair to no more than 100 watts.

25. A compact remote for receiving electrical power over at least one telephone twisted pair from a central office power supply so as to power electronics downstream from the compact remote, comprising:
a plurality of independent, isolated power converters for producing a voltage output based on receipt of a given power feed from a corresponding twisted pair, the compact remote combining the voltage outputs of each of the power converters to power downstream electronics, the given power feed received by each power converter limited to no more than 100 watts.

26. The compact remote claim 25, wherein the downstream electronics represents a load requiring in excess of 100 watts.
